(19) United States
(12) Patent Application Publication
(10) Pub. No.: US 2022/0006229 A1
(43) Pub. Date: Jan. 6, 2022

(54) WATERPROOF ELECTRICAL CONNECTOR

(71) Applicant: Molex, LLC, Lisle, IL (US)

(72) Inventors: Robert CARLSON, Batavia, IL (US); James CONDON, Lemont, IL (US)

(73) Assignee: Molex, LLC, Lisle, IL (US)

(21) Appl. No.: 17/294,047

(22) PCT Filed: Nov. 14, 2019
(86) PCT No.: PCT/US2019/061343

§ 371 Date: May 14, 2021

Related U.S. Application Data
(60) Provisional application No. 62/767,910, filed on Nov. 15, 2018.

(51) Int. Cl. H01R 13/52; H01R 13/631

(52) U.S. Cl. CPC H01R 13/5219; H01R 2201/26; H01R 13/631; H01R 13/5205

(57) ABSTRACT

An assembly includes a connector connected to a connection sleeve and which provides a moisture and debris barrier. The connector includes a terminal housing which houses terminals, a wire seal and an interface seal sealingly mounted to the terminal housing, an independent secondary lock seated within and movable relative to the terminal housing. The connection sleeve is slidable relative to the terminal housing and engages with and moves the independent secondary lock within the terminal housing to engage the terminals in the connector, and engages with the interface seal.

### RELATED APPLICATION

This application claims priority to U.S. Provisional Application No. 62/767,910, filed Nov. 15, 2018, the contents of which are incorporated herein in its entirety.

### TECHNICAL FIELD

This disclosure relates to the field of electrical connectors, in particular, electrical connectors used in a vehicle harness and having a moisture and debris barrier.

### DESCRIPTION OF RELATED ART

Waterproof electrical connectors are conventionally used, for example, for electrical connections in automobiles.

Typically, the electrical connector includes a waterproof connector housing which has a sealing member mounted in a receiving cavity thereof. The sealing member is formed of a substantially circular flat, plate-shaped main body having a plurality of electrical terminal insertion holes extending between two main surfaces thereof. A plurality of ring-shaped sealing projections is provided on an inner wall surface of each electrical terminal insertion hole which seals to terminals extending therethrough. An outer circumferential surface of the main body contacts and presses against an inner circumferential surface of the receiving cavity and forms a seal therewith. This arrangement provides a moisture and debris barrier between terminals inserted through the insertion holes and the sealing member, and between the outer circumferential surface of the sealing member and the receiving cavity of the connector housing.

In some applications, an independent secondary lock is required to increase the terminal retention force to hold the terminals within the connector housing. The independent secondary lock is typically inserted into the connector housing in a lateral orientation to provide a locking structure that directly engages a cooperating feature on the terminal. Laterally inserted components within a terminal to terminal connector system create difficulty in providing a completely sealed connector assembly.

Certain individuals can appreciate an improved sealing structure for this type of connector system.

### SUMMARY

An assembly includes a connector connected to a connection sleeve and which provides a moisture and debris barrier. The connector includes a terminal housing which houses terminals, a wire seal and an interface seal sealingly mounted to the terminal housing, an independent secondary lock seated within and movable relative to the terminal housing. The connection sleeve is slidable relative to the terminal housing and engages with and moves the independent secondary lock within the terminal housing to engage the terminals in the connector, and engages with the interface seal.

### BRIEF DESCRIPTION OF THE DRAWINGS

The present application is illustrated by way of example and not limited in the accompanying FIGS. in which like reference numerals indicate similar elements and in which:

FIG. 1 illustrates a perspective view of a waterproof electrical connector system having first and second connectors and a connection sleeve;

FIG. 2 illustrates a perspective view of an embodiment of the first connector and the connection sleeve attached thereto;

FIG. 3 illustrates an exploded perspective view of the embodiment of the first connector and the connection sleeve;

FIG. 4 illustrates a cross-sectional view, shown as a perspective, of the embodiment of the first connector the connection sleeve in a pre-load position;

FIG. 5 illustrates a cross-sectional view, shown as a perspective, of the embodiment of the first connector the connection sleeve in a final position;

FIG. 6 illustrates a perspective view of an embodiment of the first connector and terminals attached thereto;

FIG. 7 illustrates a front perspective view of a terminal housing of the first connector;

FIG. 8 illustrates a bottom plan view of the terminal housing;

FIG. 9 illustrates a rear perspective view of the terminal housing;

FIG. 10 illustrates a rear elevation view of the terminal housing;

FIG. 11 illustrates a front elevation view of an independent secondary lock of the first connector;

FIG. 12 illustrates a cross-sectional view of a connector housing of an embodiment of the first connector;

FIG. 13 illustrates an exploded perspective view of the second connector;

FIG. 14 illustrates a perspective view of the first connector exploded from the connected second connector and connection sleeve; and

FIG. 15 illustrates a perspective view of the first connector, the connection sleeve and the second connector assembled together.

### DETAILED DESCRIPTION

The detailed description that follows describes exemplary embodiments and the features disclosed are not intended to be limited to the expressly disclosed combination(s). Therefore, unless otherwise noted, features disclosed herein may be combined together to form additional combinations that were not otherwise shown for purposes of brevity. The terms “top”, “bottom”, “upper”, “lower” and the like are used for ease in description and do not denote a required orientation during use. The terms “rear” and “front” are used for description purposes only and do not denote a required orientation during use. In the description below, the term “rear” is used in denoting the direction of insertion of terminals within the system.

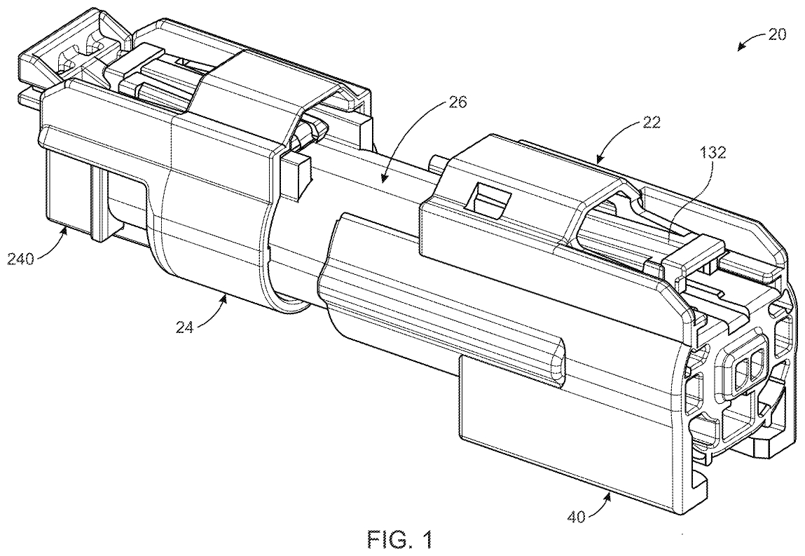

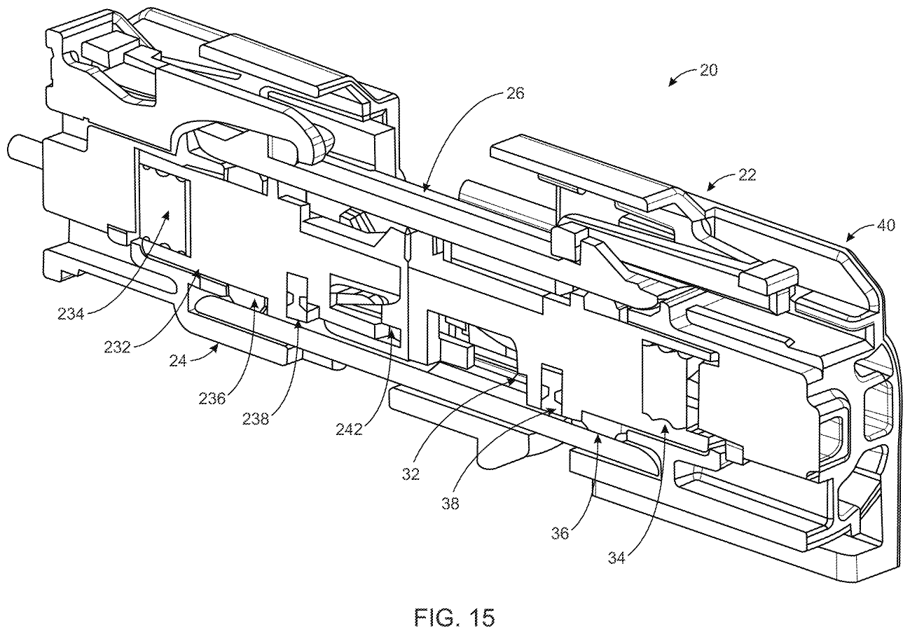

A waterproof electrical connector system 20 is shown and is typically used in an automobile or other vehicle. The connector system 20 includes a first connector 22 and a second connector 24 which mate together by a connection sleeve 26, see FIGS. 1 and 15. The first connector 22 has a plurality of electrical terminals 28 which extend therethrough, and the second connector 24 has a plurality of terminals 30 which extend therethrough. The electrical terminals 28 are attached to lead wires.

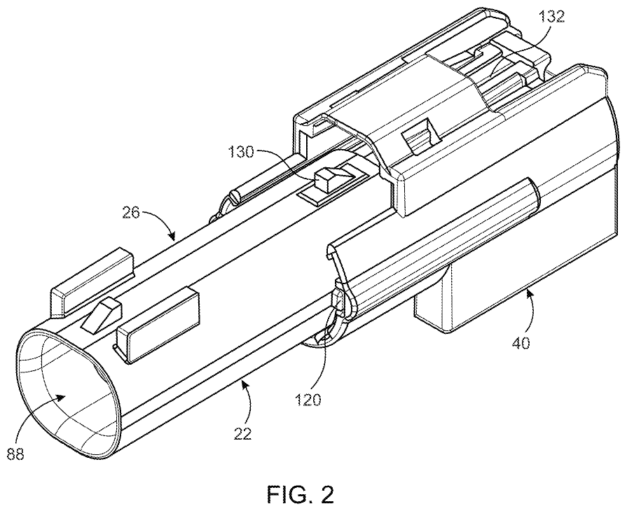

As shown in FIG. 2, the first connector 22 includes an insulative base or terminal housing 32, a first interface or wire seal 34 sealingly mounted in the terminal housing 32, a second interface or perimeter seal 36 mounted on the terminal housing 32, and an independent secondary lock 38 movably mounted to the terminal housing 32. A cover or connector housing 40 may be provided as part of the first connector 22.

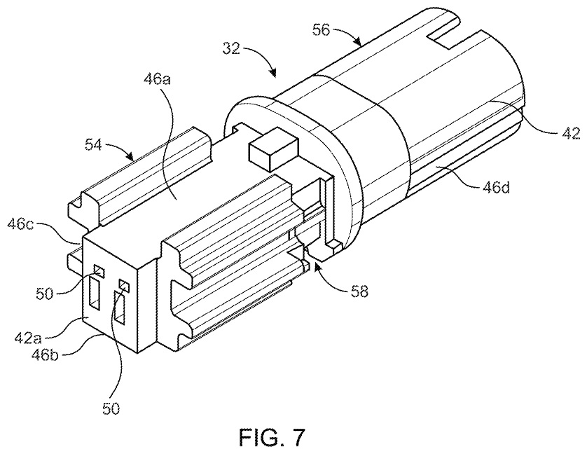

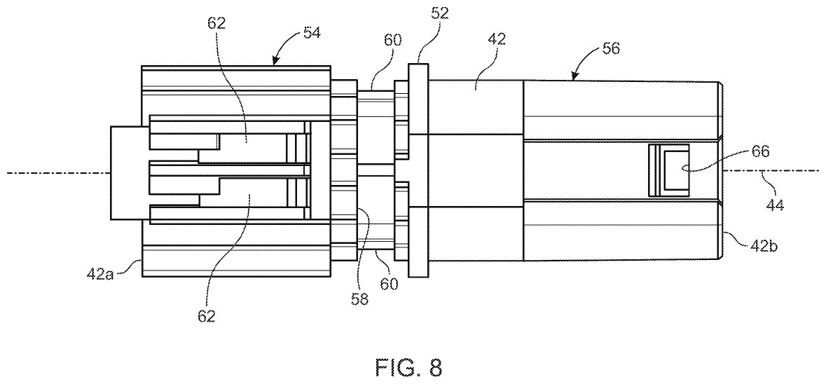

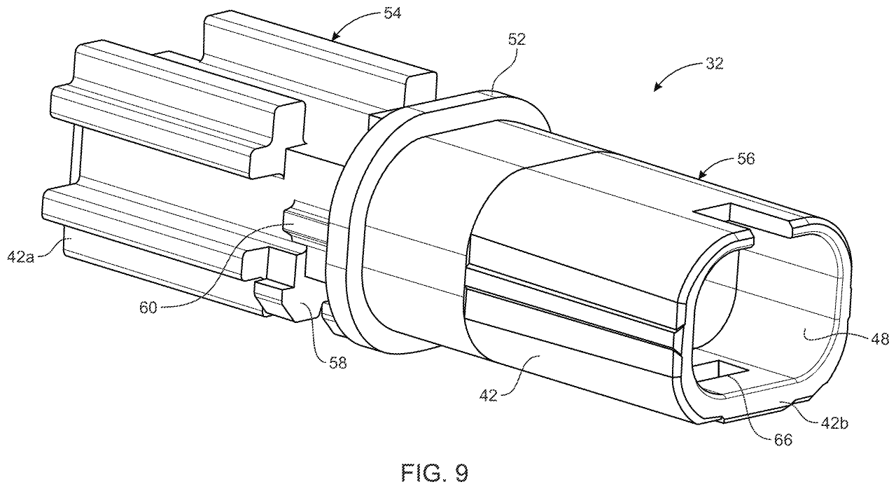

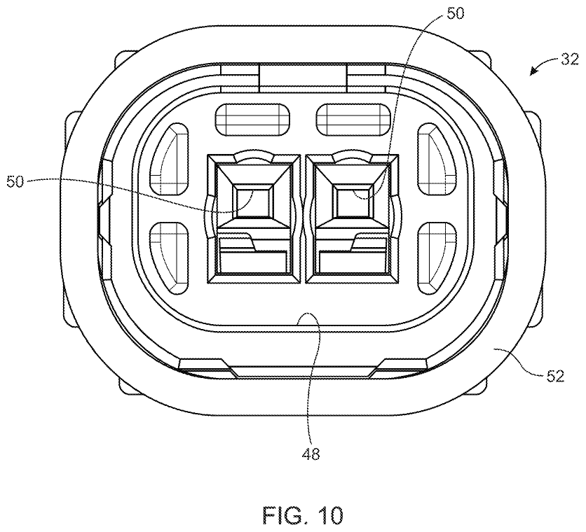

As shown in FIGS. 7-10, the terminal housing 32 is formed from a wall 42 having front and rear ends 42a, 42b and which defines a longitudinal axis 44 therebetween. The wall 42 is formed of a top wall portion 46a, an opposite bottom wall portion 46b, a first side wall portion 46c extending between the top and bottom wall portions 46a, 46b, and a second side wall portion 46d extending between the top and bottom wall portions 46a, 46b. A wire seal receiving recess 48 is defined by the wall 46 and extends longitudinally from the rear end 42b to spaced apart longitudinally extending terminal receiving cavities 50 which extend from the wire seal receiving recess 48 to the front end 42a. The wire seal receiving recess 48 is larger than the terminal receiving cavities 50. An interface seal engaging flange or shoulder 52 extends outward from an outer surface of the wall portions 46a-d, is spaced from the rear end 42b and divides the terminal housing 32 into a front portion 54 and a rear portion 56.

An independent secondary lock window 58 is formed through the bottom wall portion 46b of the front portion 54 forward of the flange 52, and which is in communication with the terminal receiving cavities 50. Each side wall portion 46c, 46d has a longitudinally extending rib 60 at approximately the midpoint thereof which extends outward from an exterior surface of the side wall portion 46c, 46d. The ribs 60 are spaced vertically above the independent secondary lock window 58.

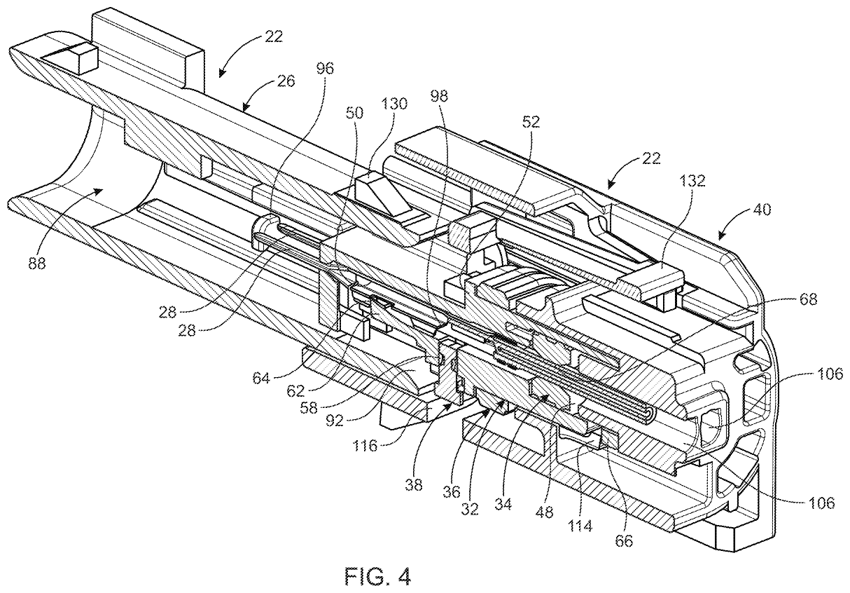

A pair of deflectable locking beams 62, see FIG. 4, are formed as part of the bottom wall portion 46b of the front portion 54. The deflectable locking beams 62 are forward of the independent secondary lock window 58 and normally overlap the terminal receiving cavities 50. Upon insertion of the terminals 28 through the terminal receiving cavities 50, the terminals 28 engage the locking beams 62 and deflect the locking beams 62 out of the terminal receiving cavities 50 so that the terminals 28 can pass by the locking beams 62. Once the terminals 28 are fully seated, a locking beam receiving window 64 in each terminal 28 aligns with the locking beams 62 and the locking beams 62 resume their undeflected position and move into the locking beam receiving windows 64 to engage and lock the terminals 28 in position within the terminal housing 32. The engagement of the locking beams 62 with the terminals 28 provides the primary lock between the terminals 28 and the terminal housing 32.

An opening 66 is formed through the bottom wall portion 46b of the rear portion 56 and is in communication with the wire seal receiving recess 48.

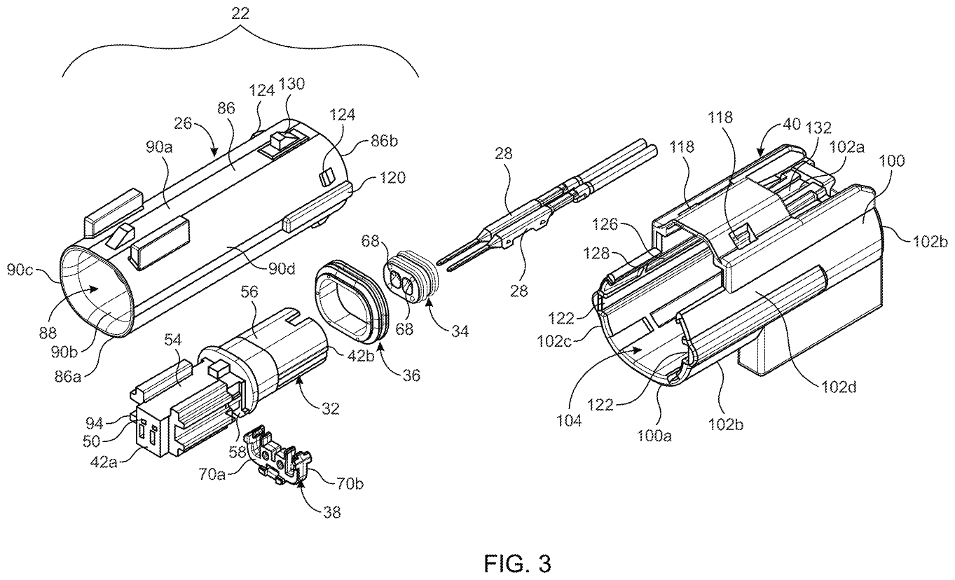

The wire seal 34, see FIGS. 3-5, is elastomeric and is seated within the wire seal receiving recess 48 of the terminal housing 32 and proximate to rear ends of the terminal receiving cavities 50. The outer edge of the wire seal 34 engages, and seals, with the inner surfaces of the wall portions 46a-d. The outer edge of the wire seal 34 may have a plurality of lobes which are compressed against the inner surfaces of the wall portions 46a-d. The wire seal 34 has a plurality of terminal receiving apertures 68 extending from a planar rear face to a planar front face thereof. The terminal receiving apertures 68 through the wire seal 34 align longitudinally with the terminal receiving cavities 50 through the terminal housing 32. The surface forming the terminal receiving apertures 68 include at least one lobe which is compressed against the respective terminal 28 when the terminal 28 is extended therethrough.

The terminals 28 extend through the terminal receiving apertures 68 of the wire seal 34 and through the terminal receiving cavities 50 through the terminal housing 32. The engagement of the wire seal 34 with the terminal housing 32 and the terminals 28 with the wire seal 34 provide a moisture and debris barrier to prevent moisture and debris from passing through the rear end 42b of the terminal housing 32.

The interface seal 36, see FIGS. 3-6, is formed from an elastomeric material and is of a frame-like configuration. The interface seal 36 is mounted over the exterior surface of the wall 42 of the rear portion 56 of the terminal housing 32 and engages against a rear face of the flange 52. The interface seal 36 has at least one lobe on the exterior surface thereof.

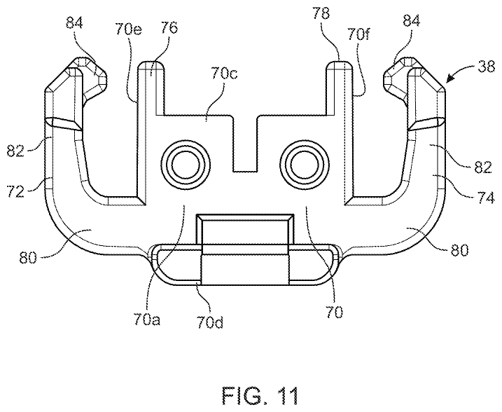

As shown in FIG. 11, the independent secondary lock 38 includes a main body 70 having a planar front face 70a, a planar rear face 70b, and surfaces 70c-e extending between the faces 70a, 70b, a first base engaging arm 72 extending upward from a lower end of the first side 70e, a second base engaging arm 74 extending upward from a lower end of the second side 70f, a first locating projection 76 extending from the top surface 70c of the main body 70 and proximate to the first base engaging arm 72, and a second locating projection 78 extending from the top surface 70c of the main body 70 and proximate to the second base engaging arm 74. Each arm 72, 74 is deflectable outwardly from the sides 70e, 70f of the main body 70. Each arm 72, 74 has a lower portion 80 which extends outward from the sides 70e, 70f of the main body 70 and an upper portion 82 which is generally perpendicular to the lower portion 80 when the arms 72, 74 are in an undeflectable condition. A finger projection 84 extends from an upper end of the upper portion 82 and toward the main body 70 and face each other.

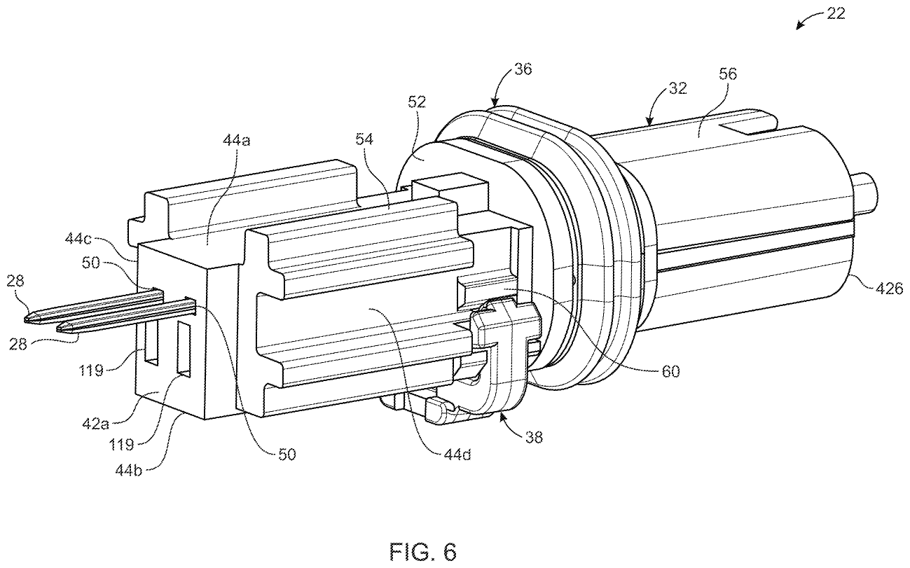

Prior to assembly with the connection sleeve 26, the independent secondary lock 38 is attached to the terminal housing 32 in a pre-load position as shown in FIGS. 4 and 6. The independent secondary lock 38 is attached to the terminal housing 32 in a lateral direction. In some embodiments, the independent secondary lock 38 is positioned at an angle to the longitudinal axis 44 of the terminal housing 32. In some embodiments, the independent secondary lock 38 is transverse to the longitudinal axis 44 of the terminal housing 32. In the pre-load position, the arm 72 is adjacent to the first side wall portion 46c of the front portion 54, the arm 74 is adjacent to the second side wall portion 46d of the front portion 54, and the locating projections 76, 78 engage side wall surfaces of the independent secondary lock window 58 but are not within the terminal receiving cavities 50. In the pre-load position, the main body 70 extends partially into the independent secondary lock window 58, and extends partially downward from the independent secondary lock window 58 as shown in FIG. 4. In the pre-load position, the finger projections 84 are below the ribs 60 on either side of the terminal housing 32 as shown in FIG. 6.

As shown in FIG. 3, the connection sleeve 26 is formed from a wall 86 which has a longitudinally extending passageway 88 provided therethrough which extends from a first end 86a of the wall 86 to a second, opposite end 86b thereof. The wall 86 has a wall portions 90a, an opposite bottom wall portion 90b, a first side wall portion 90c extending between the top and bottom wall portions 90a, 90b, and a second side wall portion 90d extending between the top and bottom wall portions 90a, 90b. The wall portions 90a-d have a chamfered surface 92 at the rear ends thereof.

The front portion 54 of the terminal housing 32 has exterior surface features forward of the ribs 60 formed thereon which allows the front portion 54 to seat within and properly align within the passageway 88 of the connection sleeve 26. As an example, the connection sleeve 26 may have a plurality of elongated, longitudinally extending keys (not shown) which seat within keyways 94 in the terminal housing 32. Some of the wall portions 90a-d, for example side wall portions 90c, 90d have blocking walls 96 which extend into the passageway 88.

In use, the connection sleeve 26 is assembled with the terminal housing 32 after the wire seal 34 and the independent secondary lock 38 have been assembled together, and after the terminals 28 have been assembled with the terminal housing 32 and the wire seal 34. As discussed above, the terminals 28 are already locked to the terminal housing 32 by the primary lock in the pre-load position. In a first position, the connection sleeve 26 is forward of the independent secondary lock window 58.

In an embodiment, to assemble the connection sleeve 26 with the terminal housing 32 to a second and final position, the independent secondary lock 38 is first moved upward in the independent secondary lock window 58 using a tool or the user's finger. During this movement of the independent secondary lock 38, the arms 72, 74 flex outward to allow the finger projections 84 to travel up and over the ribs 60, and to move the main body 70 further into the independent secondary lock window 58 and into engagement with receiving recesses 98 in the terminals 28. The receiving recesses 98 and the main body 70 form mating stop surfaces. Thereafter, the connection sleeve 26 is slid longitudinally rearward such that the second end 86b passes over the front end 42a of the terminal housing 32 and then over the front portion 54. The surface features on the front portion 54 of the terminal housing 32 and in the passageway 88 of the connection sleeve 26 properly align the terminal housing 32 within the connection sleeve 26. An inner surface of the bottom wall portion 90b of the connection sleeve 26 engages with the bottom wall 70d of the main body 70 to prevent the independent secondary lock 38 from moving laterally in the independent secondary lock window 58, thereby further securing the independent secondary lock 38 into engagement with the terminals 28 and to further secure the terminals 28 to the terminal housing 32.

In another embodiment, to assemble the connection sleeve 26 with the terminal housing 32 to a second and final position, the connection sleeve 26 is slid longitudinally rearward such that the second end 86b passes over the front end 42a of the terminal housing 32 and then over the front portion 54. The surface features on the front portion 54 of the terminal housing 32 and in the passageway 88 of the connection sleeve 26 properly align the terminal housing 32 within the connection sleeve 26. As the connection sleeve 26 is slid longitudinally rearwardly, the connection sleeve 26 contacts the independent secondary lock 38. The chamfered surface 92 on the connection sleeve 26 engages with the lower end of the main body 70 of the independent secondary lock 38 and causes the independent secondary lock 38 to move upward in the independent secondary lock window 58. During this movement of the independent secondary lock 38, the arms 72, 74 flex outward to allow the finger projections 84 to travel up and over the ribs 60, and to move the main body 70 further into the independent secondary lock window 58 and into engagement with receiving recesses 98 in the terminals 28. The receiving recesses 98 and the main body 70 form mating stop surfaces. An inner surface of the bottom wall portion 90b of the connection sleeve 26 engages with the bottom wall 70d of the main body 70 to prevent the independent secondary lock 38 from moving laterally in the independent secondary lock window 58, thereby further securing the independent secondary lock 38 into engagement with the terminals 28 and to further secure the terminals 28 to the terminal housing 32.

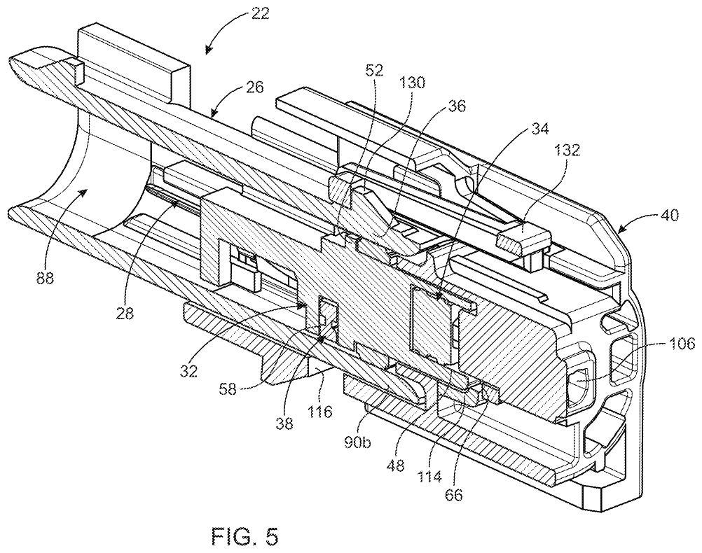

Prior to the longitudinal movement of the connection sleeve 26, the independent secondary lock window 58 provides a leak path for moisture and debris to pass therethrough. When the connection sleeve 26 is moved longitudinally, the connection sleeve 26 passes by the independent secondary lock window 58 and an inner surface of the bottom wall portion 90b of the connection sleeve 26 engages with outer surface of the interface seal 36. The engagement of the connection sleeve 26 with the interface seal 36 provides a moisture and debris barrier to prevent moisture and debris from passing between the terminal housing 32 and the connection sleeve 26 and into the independent secondary lock window 58, thereby closing the leak path. Since the independent secondary lock 38 is forward of the interface seal 36, moisture and debris cannot pass through the independent secondary lock window 58 and into the terminal receiving cavities 50. As a result, once the independent secondary lock 38 is fully engaged with the terminals 28 and the connection sleeve 26 engages with the interface seal 36, the connector 22 is the final position as shown in FIG. 5 and the first connector 22 is fully sealed against intrusion of moisture and debris.

When the connection sleeve 26 is slid longitudinally rearwardly to engage the interface seal 36, the front end 42a of the terminal housing 32 will contact the blocking walls 96 in the connection sleeve 26 to prevent the connection sleeve 26 from being further slid longitudinally rearwardly.

The first connector 22 may include the connector housing 40 as shown in the drawings. As shown, the connector housing 40 is formed from a wall 100 having front and rear ends 100a, 100b and which defines a longitudinal axis therebetween. The wall 100 is formed of a top wall portion 102a, an opposite bottom wall portion 102b, a first side wall portion 102c extending between the top and bottom wall portions 102a, 102b, and a second side wall portion 102d extending between the top and bottom wall portions 102a, 102b. A longitudinally extending passageway 104 extends from the front end 100a of the wall 100 to the rear end 100b thereof. The passageway 104 has spaced apart rear terminal receiving passageways 106 which extend from the rear end 100b forwardly to a front terminal housing receiving cavity 108. The terminal receiving passageways 106 are sized to receive the terminals 28. The front terminal housing receiving cavity 108 extends from the terminal receiving passageways 106 to the front end 100a of the wall 100. The front terminal housing receiving cavity 108 has a rear section 110 which extends from the terminal receiving passageways 106, and a front section 112 which extends from the rear section 110 to the front end 100a of the wall 100. The front section 112 is larger than the rear section 110, and the rear section 110 is sized to receive the rear portion 56 of the terminal housing 32 and the terminal housing 32 extends into the front section 112. The terminal housing 32 is radially spaced from the front section 112. The terminal receiving passageways 106 align longitudinally with the terminal receiving apertures 68 through the wire seal 34 and align longitudinally with the terminal receiving cavities 50 through the terminal housing 32 so that the terminals 28 can be passed therethrough.

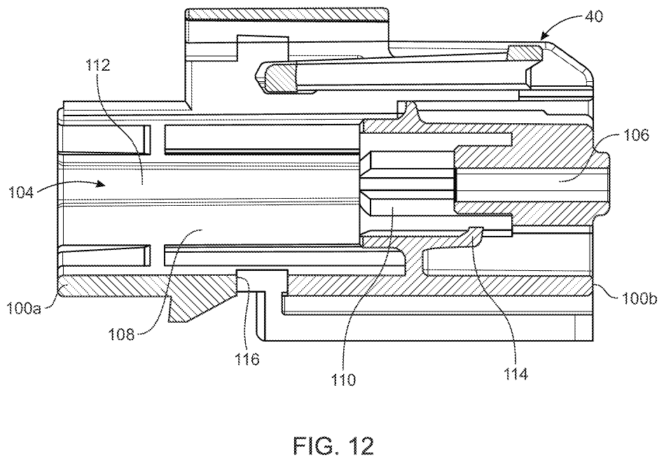

The rear section 110 further has a terminal housing engaging projection 114, see FIG. 12, extending into the rear section 110. When the terminal housing 32 is seated in the connector housing 40, the rear section 56 of the terminal housing 32 seats in the rear section 110 of the connector housing 40 and the terminal housing engaging projection 114 seats within the opening 66 to secure the terminal housing 32 and the connector housing 40 together.

When the terminal housing 32 is seated in the connector housing 40, the independent secondary lock 38 is within the front section 112. The bottom wall portion 102b has an independent secondary lock service opening 116 therethrough which is in communication with the front section 112 and aligns with the main body 70 of the independent secondary lock 38 when the terminal housing 32 and independent secondary lock 38 are seated within the connector housing 40. The independent secondary lock service opening 116 is large enough so that the independent secondary lock 38 can be moved therein. The top wall 102a has a pair of independent secondary lock service openings 118 therethrough which is in communication with the front section 112 and aligns with the finger projections 84 on the arms 72, 74 of the independent secondary lock 38 when the terminal housing 32 and independent secondary lock 38 are seated within the connector housing 40. Once the connection sleeve 26 is retracted to unblock the independent secondary lock 38 and the service openings 116, 118, and without disconnecting the terminal housing 32 from the connector housing 40, a user can insert a tool(s) through the pair of independent secondary lock service openings 118 to release the finger projections 84 and push the independent secondary lock 38 to the pre-load position such that the engagement of the independent secondary lock 38 with the terminals 28 is released.

The terminals 28 can be released from the connector 22 by a user inserting a tool through openings 119, see FIG. 6, and engaging the tool with the locking beams 62 to remove the locking beams 62 from the locking beam receiving window 64 in each terminal 28. Thereafter, the terminals 28 can be removed from the connector 22 for service and/or replacement.

The connection sleeve 26 has exterior surface features proximate to its second end 86b and the connector housing 40 has interior surface features in the front section 112 of the terminal housing receiving cavity 108 which allows the connection sleeve 26 to seat within and properly align within the terminal housing receiving cavity 108. As an example, the connection sleeve 26 may have a plurality of elongated, longitudinally extending keys 120 which seat within keyways 122 in the connector housing 40. The connection sleeve 26 has exterior surface features proximate to its second end 86b and the connector housing 40 has interior surface features in the front section 112 of the terminal housing receiving cavity 108 which allows the connection sleeve 26 to be retained within the terminal housing receiving cavity 108. As an example, the connection sleeve 26 may have a plurality of barbs 124 which seat within slots 126 in the connector housing 40. The barbs 124 snap over a wall 128 in the respective slot 126 to retain the barbs 124 within the slots 126 and to only allow a certain amount of travel distance for the connection sleeve 26 to slide longitudinally relative to the connector housing 40. In addition, the connection sleeve 26 has exterior surface features proximate to its second end 86b, such as a latching barb 130 which releasably engages with a locking latch 132 on the connector housing 40. The locking latch 132 can be depressed to release the latching barb 130.

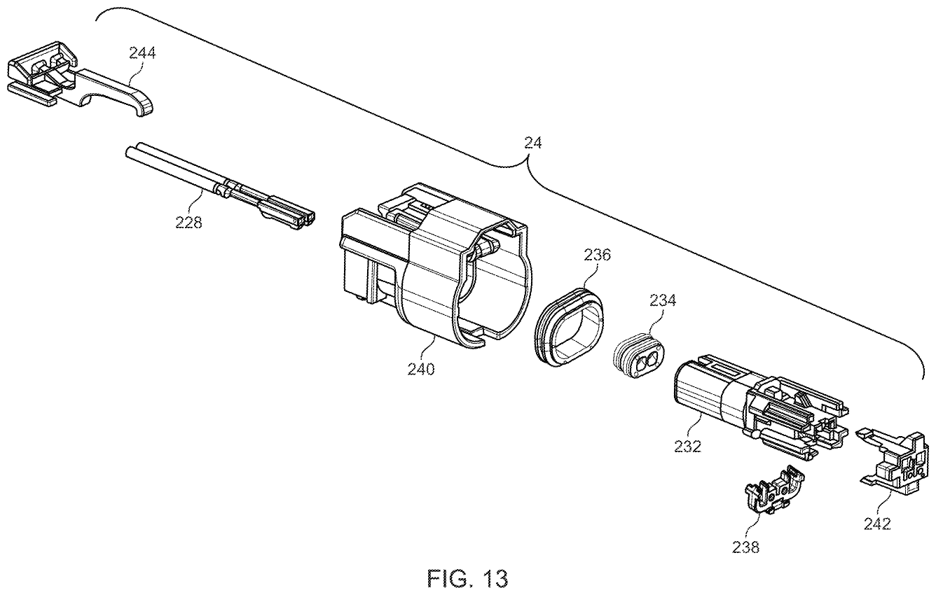

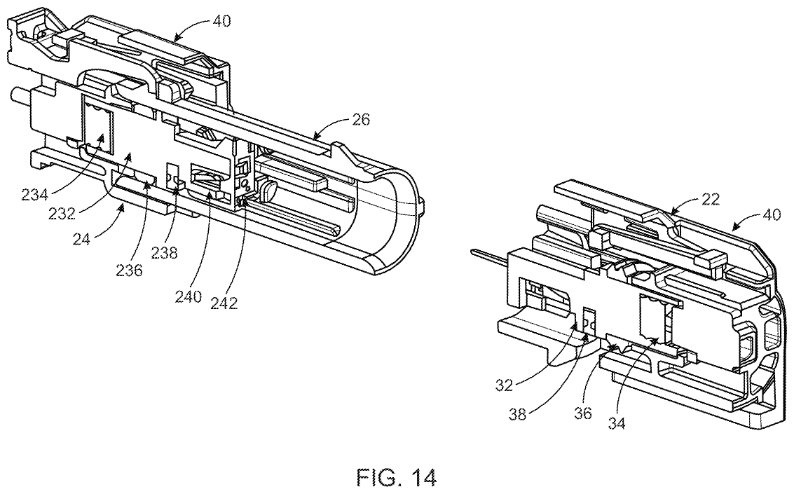

The second connector 24 is shown in FIGS. 1 and 13-15. The second connector 24 includes an insulative base or terminal housing 232, a first interface or wire seal 234 sealingly mounted in the terminal housing 232, a second interface or perimeter seal 236 mounted on the terminal housing 232, an independent secondary lock 238 movably mounted to the terminal housing 32, a cover or connector housing 240 and an insert 242. The terminal housing 232 and the insert 242 cooperatively form a securing portion or retention cavity of the second connector 24 for securing a pair of electrically conductive terminals 228 therein. The wire seal 234 and the perimeter seal 236 are disposed on the terminal housing 232 and the insert 242 and secured thereto by the connector housing 240. The independent secondary lock 238 is inserted into the terminal housing 232 in a lateral direction and communicates with terminal cavities formed in the terminal housing 232 which house the terminals 228. A connector position assurance device 244 is attached to a locking latch formed on the connector housing 240.

A portion of each terminal cavity is formed in the insert 242 that locates a mating face of each female terminal 228. A retention portion that secures the terminal 228 to the terminal housing 232 includes a deflectable locking beam located in the terminal cavity that engages a window formed in the terminal 228. A transverse window is formed on a side surface of the terminal housing 232 and communicates with each terminal cavity. An independent secondary lock 238 is disposed in the window and held in a preliminary, pre-load position.

The wire seal 234 is disposed in a recess formed in a front portion of the terminal housing 232 and includes apertures corresponding to each terminal cavity. An outer periphery of the wire seal 234 engages the side walls of the recess. The interface seal 236 is disposed on an outer surface of the terminal housing 232 and surrounds the terminal housing 232 and maintains close contact around the perimeter. A flange or shoulder formed on the terminal housing 232 locates the interface seal 236 along the terminal housing 232. The connector housing 240 is secured to a front portion of the terminal housing 232.

The connection sleeve 26 is attached to the connector housing 240 and held to the connector housing 240 by a suitable latching configuration. The connection sleeve 26 is movable between a first position and a second position within the connector housing 240. In the first position, a housing insertion edge portion of the connection sleeve 26 is inserted into an opening in the connector housing 240 and surrounds the outer periphery of the terminal housing 232. The connection sleeve 26 is advanced until the insertion edge abuts a portion of the independent secondary lock 238 that extends beyond the terminal housing 232 when the independent secondary lock 238 is in its preliminary, pre-load position. The connection sleeve 26 is fixed to the connector housing 240 and cannot be removed.

With the components of the second connector 24 assembled as described above, the terminals 228 can be inserted into each respective cavity and advanced rearward until the mating end of each terminal 228 abuts the end of each cavity portion formed in the insert 242. Upon insertion, the terminals 228 pass through the wire seal 234 and permit the apertures in the wire seal 234 to intimately engage the wire insulation portions of the terminals 228 providing a moisture and debris barrier. The terminals 228 are further advanced in the cavity and are preliminarily locked in each cavity by each respective locking beam.

Upon complete insertion of the terminals 228, the independent secondary lock 238 is moved from its preliminary, pre-load position to its final position whereby a stop surface formed on the independent secondary lock 238 abuts cooperating stop surface formed on the terminal 228 and further locks the terminal 228 within the cavity. This provides a secondary lock that further restricts the terminals 228 form being withdrawn from the cavity. In its final position, the independent secondary lock 238 no longer protrudes beyond the outer body surface of the terminal housing 232 therefore allowing the connection sleeve 26 to be moved to its second and final position.

Upon movement of the connection sleeve 26 to its second position, an inner surface of the connection sleeve 26 maintains intimate contact with the interface seal 236. The contact prevents the ingress of moisture and debris into the mating interface of the second connector 24 and the connection sleeve 26.

Upon mating of the two connectors 22, 24 together, the connection sleeve 26 is similarly latched on each of the connectors 22, 24. With this construction, the connection sleeve 26 effective functions as an adapter between the first and second connectors 22, 24. Essentially, the mating interface of each connector 22, 24 is the same, in this case, male to male. The connection sleeve 26 is essentially a female to female adapter. This allows a similar sealing arrangement on both connectors 22, 24, therefore creating a completely sealed wire-to-wire arrangement with an independent secondary lock 38, 238 on each connector 22, 24.

While the first and second connectors 22, 24 are shown with only terminals 28, 228, the connectors 22, 24 could have two rows of terminals 28, 228 with latching appropriate locking beams 62 and a second independent secondary lock 38, 238 mounted opposite to the first independent secondary lock 38, 238.

As can be appreciated from the various embodiments depicted herein, different features of different embodiments depicted herein can be combined together to form additional combinations. As a result, the embodiments depicted herein are particularly suitable to provide a wide range of configurations that were not all depicted individually so as to avoid repetitiveness and unnecessary duplication.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

We claim:

1. An assembly comprising:
a connector comprising
a terminal housing configured to receive terminals therethrough, the terminal housing having a front end and rear end and defining a longitudinal axis therebetween, a wire seal receiving recess extending longitudinally from the rear end, terminal receiving cavities extending longitudinally from the wire seal receiving recess to the front end of the terminal housing, and an independent secondary lock window in communication with the terminal receiving cavities,
a wire seal sealingly mounted within the wire seal receiving recess, the wire seal having terminal receiving apertures extending therethrough,
an interface seal sealingly mounted to an external surface of the terminal housing, the interface seal being rearward of the independent secondary lock window, and
an independent secondary lock seated within the independent secondary lock window forward of the wire seal and the interface seal, and movable relative to the terminal housing; and
a connection sleeve slidable relative to the terminal housing and capable of engagement with the interface seal.

2. The assembly of claim 1, wherein the independent secondary lock is movable relative to the terminal housing in a direction which is angled relative to the longitudinal axis of the terminal housing.

3. The assembly of claim 1, wherein the independent secondary lock is movable relative to the terminal housing in a lateral direction.

4. The assembly of claim 1, wherein the independent secondary lock comprises a pair of arms, wherein the independent secondary lock is attached to the terminal housing in a pre-load position by the pair of arms which engage with the terminal housing.

5. The assembly of claim 4, wherein each arm is flexible and has a finger projection extending therefrom, and the terminal housing has a pair of ribs extending therefrom, wherein the arms flex and the finger projections move over the ribs upon movement of the independent secondary lock from the pre-load position to a final position.

6. The assembly of claim 1, further comprising an outer housing, and wherein the terminal housing is non-movably attached to the outer housing, the connection sleeve is attached to the outer housing and slidable relative thereto, and the interface seal is not in contact with the outer housing, the outer housing having terminal receiving cavities therethrough in communication with the wire seal receiving recess.

7. The assembly of claim 6, wherein the outer housing has an opening therethrough which aligns with the independent secondary lock window in the terminal housing.

8. The assembly of claim 7, wherein the outer housing further has a pair of openings therethrough which are aligned with, but spaced from the independent secondary lock window in the terminal housing.

9. The assembly of claim 1, further comprising a terminal mounted with each terminal receiving passageway, each terminal having a recess therein, the independent secondary lock being configured to engage with the recesses upon movement of the independent secondary lock within the independent secondary lock cavity.

10. The assembly of claim 9, wherein the terminal housing has deflectable locking beams which are configured to engage with windows in the terminals.

11. The assembly of claim 10, wherein the deflectable locking beams are forward of the independent secondary lock window.

12. The assembly of claim 1, further comprising a second connector which houses terminals therein, and wherein the connection sleeve is configured for engagement with the second connector.

13. The assembly of claim 1, wherein the connection sleeve is further capable of engagement with the independent secondary lock to move the independent secondary lock within the independent secondary lock window to partially block the terminal receiving cavities.

14. A connector assembly comprising:
a first connector, the first connector having a first independent secondary lock and a first interface seal;
a second connector, the second connector having a second independent secondary lock and a second interface seal; and
a connection sleeve, wherein the connection sleeve is configured to mate with the first and second connector and maintain contact between the connection sleeve and the first and second interface seals.

15. The connector assembly of claim 14, wherein the first connector further comprises
a terminal housing configured to receive terminals therethrough, the terminal housing having a front end and rear end and defining a longitudinal axis therebetween, a wire seal receiving recess extending longitudinally from the rear end, terminal receiving cavities extending longitudinally from the wire seal receiving recess to the front end of the terminal housing, and an independent secondary lock window in communication with the terminal receiving cavities,
a wire seal sealingly mounted within the wire seal receiving recess, the wire seal having terminal receiving cavities extending therethrough,
an interface seal sealingly mounted to an external surface of the terminal housing, the interface seal being rearward of the independent secondary lock window,
the independent secondary lock of the first connector being seated within the independent secondary lock window forward of the wire seal and the interface seal, and movable relative to the terminal housing; and
wherein the connection sleeve is slidable relative to the terminal housing and capable of engagement with the interface seal.

16. The connector assembly of claim 15, wherein the connection sleeve is further capable of engagement with the independent secondary lock to move the independent secondary lock within the independent secondary lock window to partially block the terminal receiving cavities.

17. An assembly comprising:
a connector comprising
a terminal housing configured to receive terminals therethrough, the terminal housing having a front end and rear end and defining a longitudinal axis therebetween, a wire seal receiving recess extending longitudinally from the rear end, terminal receiving cavities extending longitudinally from the wire seal receiving recess to the front end of the terminal housing, and an independent secondary lock window in communication with the terminal receiving cavities,
a wire seal sealingly mounted within the wire seal receiving recess, the wire seal having terminal receiving apertures extending therethrough,
an interface seal sealingly mounted to an external surface of the terminal housing, the interface seal being rearward of the independent secondary lock window, and
an independent secondary lock seated within the independent secondary lock window forward of the wire seal and the interface seal, and movable in a lateral direction relative to the terminal housing; and
a connection sleeve longitudinally slidable relative to the terminal housing and capable of engagement with the interface seal, wherein the connection sleeve is configured to be positioned in a first position which permits movement of the independent secondary lock, and is configured to be positioned in a second position which blocks the independent secondary lock window.

18. The assembly of claim 17, further comprising an outer housing, and wherein the terminal housing is non-movably attached to the outer housing, the connection sleeve is attached to the outer housing and longitudinally slidable relative thereto, and the interface seal is not in contact with the outer housing, the outer housing having terminal receiving cavities therethrough in communication with the wire seal receiving recess.

19. The assembly of claim 17, further comprising a terminal mounted with each terminal receiving passageway, each terminal having a recess therein, the independent secondary lock being configured to engage with the recesses upon movement of the independent secondary lock within the independent secondary lock cavity.

20. The assembly of claim 19, wherein the terminal housing has deflectable locking beams which are configured to engage with windows in the terminals.
